(19) United States
(12) Patent Application Publication
(10) Pub. No.: US 2003/0128285 A1
(43) Pub. Date: Jul. 10, 2003

(54) Image pickup apparatus

(76) Inventor: Hiroshi Itoh, Tokyo (JP)

Correspondence Address: STRAUB & POKOTYLO, 1 BETHANY ROAD, SUITE 83, BUILDING 6, HAZLET, NJ, 07730, US

(21) Appl. No.: 10/331,267

(22) Filed: Dec. 30, 2002

(30) Foreign Application Priority Data
Jan. 9, 2002 (JP) 2002-1921

(51) Int. Cl. H04N 9/64

(52) U.S. Cl. 348/246; 348/296; 348/244; 348/229.1

(57) ABSTRACT

An image pickup apparatus including: CCD image pickup device for converting object light into electrical signals; a light cutoff plate; an exposure controlling section for controlling the light cutoff plate and image pickup device to control exposure period of the image pickup device; a dark signal storage section for storing dark signals obtained from the image pickup device in the condition where the incident light is cut off by the light cutoff plate; a subtracting section for subtracting dark signals stored at the storage section from the main exposure image pickup signals obtained at the image pickup device by a main exposure where the light cutoff plate is withdrawn; a defect detecting section for detecting fault pixels from the image pickup signals after the subtraction of dark current components; and a correcting section for correcting the detected fault pixels. The detection of fault pixels is performed with respect to the image pickup signals canceled of the dark current components so that the fault pixels can be accurately detected.

This application claims benefit of Japanese Application No. 2002-1921 filed in Japan on Jan. 9, 2002, the contents of which are incorporated by this reference.

### BACKGROUND OF THE INVENTION

The present invention relates to image pickup apparatus in which it is possible to eliminate dark current components occurring at image pickup device such as a solid-state image pickup device and to detect and correct fault pixels so that suitable image pickup signals can be obtained.

In recently developed image pickup apparatus, solid-state image pickup devices typically represented by CCD are commonly used as an image pickup/input device. A solid-state image pickup device is an aggregate of several millions of very small pixels and input light is converted into an electric charge at each pixel and is outputted as image signal according to the amount of light. At this time, the generated electric charge does not become zero even when the amount of incident light rays has been brought to zero, and an electric charge is caused to occur due to temperature, i.e., heat. Output currents resulting from the electric charge occurring due to such heat are generally referred to as dark currents and are always superimposed on the image signal output as a noise component that depends on temperature and time and has nothing to do with the amount of light. Further, the dark current components in performing a long-time exposure image taking for example by a digital camera are caused to appear within the image as noise in the manner of extreme pixel defects, since the amount of occurrence of electric charge for generating such dark current components varies from one pixel to another. Accordingly, method of subtracting a light cutoff image of the same taking period from the taken image has been known for long as an eliminating technique therefor.

According to such dark current eliminating method, however, image taking time for two images, i.e., an image to be photographed and a light cutoff image is required to obtain one image which is processed of the noise. The operability is inferior due to a large waste in the image taking timing. A dark current component eliminating method as described below has been known as the method for dealing with this.

In particular, Japanese Patent Publication No.63-59632 discloses a method in which dark current components are predicted by an operation expression from temperature and exposure time in the image taking and such dark current components are electrically subtracted from the taken image to eliminate the dark current components, thereby eliminating the waste of a time period for taking a light cutoff image.

Further, of a solid-state image pickup device, some pixels end up as defect for the reasons other than the above described dark current variance, such as the destruction of their function as pixel in the process of manufacture in which case a certain level is outputted irrespective of the amount of exposure. These fault pixels always appear within the image as abnormal pixel signals irrespective of whether the exposure time is relatively long or not. The method below is known as a technique for elimination thereof.

In particular, Japanese patent laid-open application No.2000-125313 discloses a method for correcting defects in which a normal signal level is inferred from surrounding pixel signals by computation such that, for each observed pixel within a selected scene, correlation with neighboring pixels is computed and quantified by operation so that the observed pixel is determined as normal when the correlation is high or as abnormal, i.e., defect when it is low.

In the method as disclosed in the above mentioned Japanese Patent Publication NO.63-59632, however, though the waste in picture taking time is eliminated, it is impossible to deal with the pixel-by-pixel variance of dark currents, since a fixed value determined by temperature and exposure time is uniformly subtracted from the pixel signals of all pixels. For this reason, noises in the manner of pixel defects are all left untreated of the image pickup signals after the subtraction processing. Further, subtraction error resulting from a dynamic range limitation of circuit occurs when dark currents are subtracted, and there is a problem that the portions of such subtraction error are also left untreated as noise in the manner of pixel defects.

A description will now be given by way of FIG. 1 and FIGS. 2A to 2D with respect to subtraction error resulting from the above described dynamic range limitation. FIG. 1 shows an object of which signal levels are smoothly increased toward the right side in the horizontal direction, i.e., from location k to location l; and FIGS. 2A to 2D show image pickup output signals obtained by taking the object shown in FIG. 1. In FIGS. 2A to 2D, the axis of ordinates indicates signal level and the axis of abscissas indicates pixel location in the horizontal direction so as to represent a signal output waveform when a plurality of pixels along a specific line within the object shown in FIG. 1 are sequentially read out. The horizontal positions k, l in the object shown in FIG. 1 correspond to pixel locations k, l in the signal waveforms shown in FIGS. 2A to 2D. The main exposure image pickup signals ideally result in the waveform as shown in FIG. 2A.

In general, while a main exposure image pickup signal is constituted mainly by dark current component and object signal component, there is an absolute limitation in the dynamic range (indicated by D in FIG. 2A) of the circuit through which the signal is transmitted. As the portions of pixel locations X1, X2 in FIG. 2B which indicates realistic main exposure signals, the signal portions exceeding the dynamic range D are actually clipped and are treated as the same level with each other. Particularly, at the time of a long-time exposure image taking, if, of the main exposure image pickup signal, the dark current component (indicated by dotted pattern) becomes to occupy a large portion of the taken image signal as X1 portion in FIG. 2B, the signal level is clipped of the main exposure image pickup signal. As X1, X2 portions of FIG. 2C which indicates the dark signals (dark current components) of the same locations, however, there occur conditions in which clipping is not performed when only the dark current components are considered. It should be noted here that unevenness in dark current levels indicates an occurrence of pixel-by-pixel variance.

At this time, when the dark current components (FIG. 2C) are subtracted from the main exposure image pickup signals (FIG. 2B), of those portions where the dark signals (dark current components) to be subtracted are greater, signal outputs cut down toward the lower level side at such positions than the genuine object signal outputs are caused to result as X1, X2 portions of FIG. 2D which indicates the main exposure image pickup signals after the dark signal subtraction processing. Especially in respect of a low luminance object, those pixels having extremely large dark current components are to become fault pixels having slightly different level from the surrounding pixels in low luminance portions. These are in many cases, therefore, not detected as fault pixels and are untreated even if detection of defects is attempted at a subsequent stage. Moreover, in an ordinary image pickup apparatus, low luminance portions are likely to be processed as multiplied by a higher gain than high luminance portions in the image processing of subsequent stages as indicated by the solid line in the gain processing diagram of FIG. 3 and, if not detected/treated as fault pixels as the above, become more conspicuous fault pixels to make the image poor.

It should be noted that, while FIGS. 2A to 2D have been used to exemplify the case where the dark current level varies from one pixel to another, the following problem still occurs even if such pixel-by-pixel variance of dark current level is zero. In particular, since dark current components B (dotted pattern) are increased as shown in FIG. 4B for example in a long-time exposure, an image (image pickup signals), which could have been taken without being clipped as shown in FIG. 4A which indicates the image pickup signals taken in a normal-time duration, is caused to appear as shown in FIG. 4C as a result that the dark current components have been eliminated. In other words, the resulting image (image pickup signals) is clipped of the upper portions of luminance level which are not clipped in the normal case.

On the other hand, a black level must be recognized at all times in processing the image pickup signals. A reference level for such purpose is provided (usually, the black level itself is used as the reference). In a long-time exposure image taking where dark current becomes greater or in the case where a gain up/down processing is performed at a processing circuit of subsequent stage, the black level and the amount of random noise fluctuate, causing a problem that an unnecessary components are put into the dynamic range of the circuit or that necessary components exceed the dynamic range.

A loss of dynamic range due to fluctuation in the black level will now be described by way of FIGS. 5A and 5B. For ease of explanation, a description will be given below with respect to the case where a point other than the black level at which the image pickup signal level becomes stable is used as the reference level. Since those necessary at the end as the signal components are the components above the black level, a reference level p is generally set as shown in FIG. 5A so as to include such black level in the lowest level of the dynamic range D of the circuit. In the case of a long-time exposure image taking or when the circuit gain is increased by using the reference level as the reference as shown in FIG. 5B, a loss of dynamic range corresponding to that indicated by L in FIG. 5B occurs in the circuit where the reference level is always kept constant.

Further, in the case where a subtraction of dark current components as described above is performed, since the relative magnitude of the level of the dark current components is influenced by temperature and exposure time of the solid-state image pickup device at the time of main exposure image taking, most of the photographers actually using the image pickup apparatus cannot make a judgment as to whether or not the dark current subtraction processing becomes effective at what degree of temperature and how long the exposure time has become. If such dark current subtraction is performed at all times, on the other hand, a loss of power results. In addition, since one main-exposure taken image is generated by two times of image taking in the conventional method where dark signals obtained by cutting off light are to be subtracted, a problem occurs that loss in the image taking time also becomes double.

According to the method as disclosed in Japanese patent laid-open application No.2000-125313, although fault pixels can be detected irrespective of dark currents, it is premised that those pixels surrounding the observed pixel are not defective. For this reason, in the condition such as long-time exposure image taking where defects occur frequently as located closely to each other, there is a problem that detection of defects becomes impossible or that normal pixels are erroneously detected as defects.

### SUMMARY OF THE INVENTION

To eliminate the above problems in image pickup apparatus having a conventional means for eliminating dark currents or in image pickup apparatus having a means for correcting defects, it is an object of the present invention to provide an image pickup apparatus in which dark current components occurring at image pickup device can be eliminated so that fault pixels are accurately detected. It is another object of the invention to provide an image pickup apparatus in which dark current components occurring at image pickup device can be eliminated with greatly reducing a loss in time for taking image so that fault pixels are accurately detected.

In accordance with a first aspect of the invention, there is provided an image pickup apparatus including: an image pickup device having a plurality of pixels for effecting photoelectric conversion of an incident light; light cutoff means for cutting off the incident light to the image pickup device; exposure control means for setting and controlling diaphragm stop and image taking time; memory means for storing an output of the image pickup device; subtraction means for subtracting dark signals obtained at the image pickup device at the time of cutting off the incident light by the light cutoff means from main exposure image pickup signals obtained at the image pickup device at the time of main exposure image taking where the light cutoff means is withdrawn; detection means for detecting defect signals due to fault pixels of the image pickup device from the image pickup signals after the subtraction processing obtained at the subtraction means; and correction means for correcting the defect signals.

In image pickup apparatus, fault pixels occur in every portion within image for example in a long-time exposure image taking. The detection accuracy thereof becomes extremely low. In the first aspect of the invention, however, the fault pixels can be accurately detected, since dark signals obtained by cutting off light are subtracted from image pickup signals of main exposure image taking and fault pixels are detected with respect to the subtraction signals after the cancellation of dark current components.

In the first aspect of the invention, the light cutoff means is preferably capable of setting a light cutoff. period corresponding to the taking time of the main exposure image taking. Thereby the signals obtained from the subtraction of dark signals acquired by cutting off light for an equivalent time period as the main exposure image taking can be used for the detection of fault pixels so that fault pixels can be more accurately detected.

In accordance with a second aspect of the invention, there is provided an image pickup apparatus including: an image pickup device having a plurality of pixels for effecting photoelectric conversion of an incident light; temperature detection means for detecting a temperature of the image pickup device; exposure control means for setting and controlling diaphragm stop and image taking time; dark signal computing means for generating by computation dark signals of the image pickup device on the basis of the temperature detected by the temperature detection means and the image taking time set by the exposure control means; subtraction means for subtracting the dark signals obtained at the dark signal computing means from main exposure image pickup signals obtained at the image pickup device at the time of main exposure image taking; detection means for detecting defect signals due to fault pixels of the image pickup device from the image pickup signals after the subtraction processing obtained at the subtraction means; and correction means for correcting the defect signals.

In thus constructed image pickup apparatus, a loss in the image taking time can be greatly reduced, since light cutoff signals other than those of main exposure image taking, i.e., dark signals obtained from the image pickup device at the time of cutting off an incident light are not required to be obtained in the subtraction process of dark signals which is to be performed at a preceding stage of the detection/correction processing of fault pixels.

In accordance with a third aspect of the invention, the image pickup apparatus according to the first aspect further include temperature detection means for detecting a temperature of the image pickup device, and the exposure control means effects control so that a light cutoff period corresponding to the temperature detected at the temperature detection means can be set to the light cutoff means.

While a greater number of defects occur in the image pickup device when its temperature is higher, a temperature difference occurs in a long-time exposure image taking due to the fact that a time difference occurs between the main exposure image taking and dark image taking. In some cases, therefore, the effect of canceling dark components by the subtraction processing of dark signals obtained by cutting off light for the same period as the main exposure image taking is reduced. In the third aspect of the invention, dark signals are controlled by controlling the light cutting off time with considering such change amount in temperature so that dark current components can be accurately canceled even in the case where temperature drastically changes.

In accordance with a fourth aspect of the invention, the subtraction means of the image pickup apparatus according to the first aspect includes adjusting means for multiplying the level of dark signals at the time of cutting off the incident light by a predetermined number of times, and the level of dark signals at the time of cutting off the incident light obtained by setting a light cutoff period shorter than the image taking time of the main exposure image taking to the light cutoff means is multiplied by a predetermined number of times by the adjusting means and then subtracted from the main exposure image pickup signals.

Since the level of dark current components is increased roughly proportionally to time, the amount of dark current components contained in the main exposure image pickup signals that can be roughly canceled can be attained by obtaining dark signals of a period shorter than the main exposure image taking time and then multiplying the same by a predetermined number of times. Accordingly, a dark current suppressing effect of relatively high accuracy can be obtained with a shorter loss in image taking time by subtracting the dark signals multiplied by the predetermined number from the main exposure image pickup signals.

In accordance with a fifth aspect of the invention, the image pickup apparatus according to the first or second aspect further includes a first adjusting means for multiplying the level of image pickup signals from the image pickup device by 1/N (N≠0) times, and a second adjusting means for multiplying the image pickup signals after the subtraction processing by N times, wherein the first adjusting means multiplies by 1/N the main exposure image pickup signals and dark signals at the time of cutting off the incident light or dark signals obtained from the dark signal computing means and the second adjusting means multiplies by N the image pickup signals after the subtraction processing having been subjected to the subtraction processing at the subtraction means.

While for example in a long-time exposure image taking, the dark current component grows to occupy a large portion of the dynamic range of a circuit, both the main exposure image pickup signals and dark signals are previously reduced to 1/N as in the fifth aspect. Thereby the signal loss resulting from the dynamic range limitation of the circuit can be greatly reduced by performing the subtraction processing for canceling the dark current in the state where the portion occupied by dark current component in the dynamic range is reduced, i.e., in the condition of maximally utilizing the dynamic range and by multiplying the signals after such processing by N.

In accordance with a sixth aspect of the invention, the first adjusting means of the image pickup apparatus according to the fifth aspect causes the level for clamping the image pickup signals from the image pickup device to vary correspondingly to image taking time.

It is thereby possible to utilize the dynamic range of the circuit more effectively even under the condition where a fluctuation in black level occurs.

In accordance with a seventh aspect of the invention, of the image pickup apparatus according to the first aspect, the memory means integrates for a plurality of frames and stores dark signals obtained at the time of cutting off the incident light by the light cutoff means and the subtraction means subtracts the integrated dark signals from the main exposure image pickup signals.

While random noise is superimposed on every signal component, the level of the random noise component can be suppressed by means of integration. Accordingly, as in the seventh aspect, dark signals not influenced by object are obtained for a plurality of frames and the same pixel within the image is integrated for the number of times of obtained frames to suppress random noise in the dark signals. By subtracting thus obtained integrated dark signals from the main exposure image pickup signals, it is possible to obtain dark current suppressed signals which are further improved in noise level. It also becomes possible to reduce loss in image taking time as compared to the ordinary by obtaining a dark signal of short period for a plurality of times.

In accordance with an eighth aspect of the invention, the image pickup apparatus of the first or second aspect includes determining means for determining whether a circuit-saturated pixel signal occurs within the main exposure image pickup signals or not, wherein the subtraction means does not perform subtraction processing for the circuit-saturated pixel signals occurring within the main exposure image pickup signals as determined by the determining means and outputs the same as an output signal of the subtraction means without change.

By such construction, detection of fault pixels left in the main exposure image pickup signals after subtracting dark signals becomes easier especially on the lower luminance side.

In accordance with a ninth aspect of the invention, the image pickup apparatus according to the first aspect is adapted to obtain the main exposure image pickup signals before acquiring dark signals at the time of cutting off the incident light.

In accordance with a tenth aspect of the invention, the image pickup apparatus according to the ninth aspect includes detection means for detecting a circuit-saturated condition of image pickup signal at the time of the main exposure image taking and means for deciding whether or not to acquire dark signals at the time of cutting off the incident light in accordance with the circuit-saturated condition detected by the detection means.

In the condition where many of the main exposure image pickup signals are circuit-saturated, a normal image is impossible to be obtained even if dark signals are eliminated, since a lot of information is clipped and lost due to the fact that the dynamic range of the circuit is correspondingly cut down. Therefore, the above ninth and tenth aspects are constructed to prohibit continuation of such abnormal image taking so that a loss in the image taking time and power can be prevented by eliminating the operation of acquiring and subtracting dark signals by cutting off light after the main exposure image taking.

In accordance with an eleventh aspect of the invention, the image pickup apparatus according to the ninth aspect includes detection means for detecting circuit-saturated condition of image pickup signal at the time of the main exposure image taking, wherein the exposure control means controls the image taking time and exposure amount in accordance with the circuit-saturated condition detected by the detection means.

By thus optimizing the exposure condition, it is possible not to acquire abnormal images.

In accordance with a twelfth aspect of the invention, the image pickup apparatus according to the ninth aspect further includes detection means for detecting a circuit-saturated condition of image pickup signal at the time of the main exposure image taking, and means for indicating to the photographer an information relating to an optimal image taking time and exposure amount in accordance with the circuit-saturated condition detected by the detection means.

By such construction, the photographer can perform an optimal image taking by recognizing an optimal image taking time and exposure amount so that a loss in the image taking time and power can be prevented.

In accordance with a thirteenth aspect of the invention, the image pickup apparatus according to the first or second aspect further includes temperature detection means for detecting a temperature of the image pickup device, and includes means for deciding whether or not to perform dark current subtraction processing by acquiring dark signals at the time of cutting off the incident light or whether or not to perform dark current subtraction processing by computing dark signals at the dark signal computing means in accordance with a temperature detection result detected by the temperature detection means and the diaphragm stop and image taking time set by the exposure control means.

As previously described in the section of the prior art and problems, because of characteristics of image pickup device, the level of dark current can be roughly inferred from a function of temperature and time. In the thirteenth aspect, the image pickup apparatus automatically makes judgment by itself at all times based on such inferred value as to whether or not a photographed image subtracted of dark currents can be normally taken so as to decide whether or not to perform dark current subtraction processing. It is thereby possible to always take a normal image within the performance of the image pickup apparatus without a photographer's judgment on the conditions.

### BRIEF DESCRIPTION OF THE DRAWINGS

FIG. 1 shows an example of object to be taken.

FIGS. 2A to 2D show an example of image pickup output signals when taking the object shown in FIG. 1.

FIG. 3 shows the manner of gain processing of image pickup signals.

FIGS. 4A to 4C show an example of signal waveforms at the time of the conventional dark current subtraction processing.

FIGS. 5A and 5B are illustrations for explaining loss in dynamic range due to fluctuation in black level.

FIG. 6 is a block diagram showing a first embodiment of the image pickup apparatus according to the invention.

FIG. 7 is a timing chart for explaining operation of the first embodiment shown in FIG. 6.

FIG. 8 is a block diagram showing a second embodiment of the invention.

FIG. 9 is a block diagram showing a third embodiment of the invention.

FIG. 10 is a block diagram showing a fourth embodiment of the invention.

FIG. 11 is a timing chart for explaining operation of the fourth embodiment shown in FIG. 10.

FIG. 12 is a block diagram showing a fifth embodiment of the invention.

FIG. 13 is a timing chart for explaining operation of the fifth embodiment shown in FIG. 12.

FIG. 14 is a block diagram showing a modification of the fifth embodiment shown in FIG. 12.

FIG. 15 is a block diagram showing a sixth embodiment of the invention.

FIGS. 16A to 16F show signal waveforms for explaining operation of the sixth embodiment shown in FIG. 15.

FIGS. 17A to 17C show signal waveforms for explaining another operation of the sixth embodiment shown in FIG. 15.

FIG. 18 is a block diagram showing a seventh embodiment of the invention.

FIG. 19 show signal waveforms for explaining operation of the seventh embodiment shown in FIG. 18.

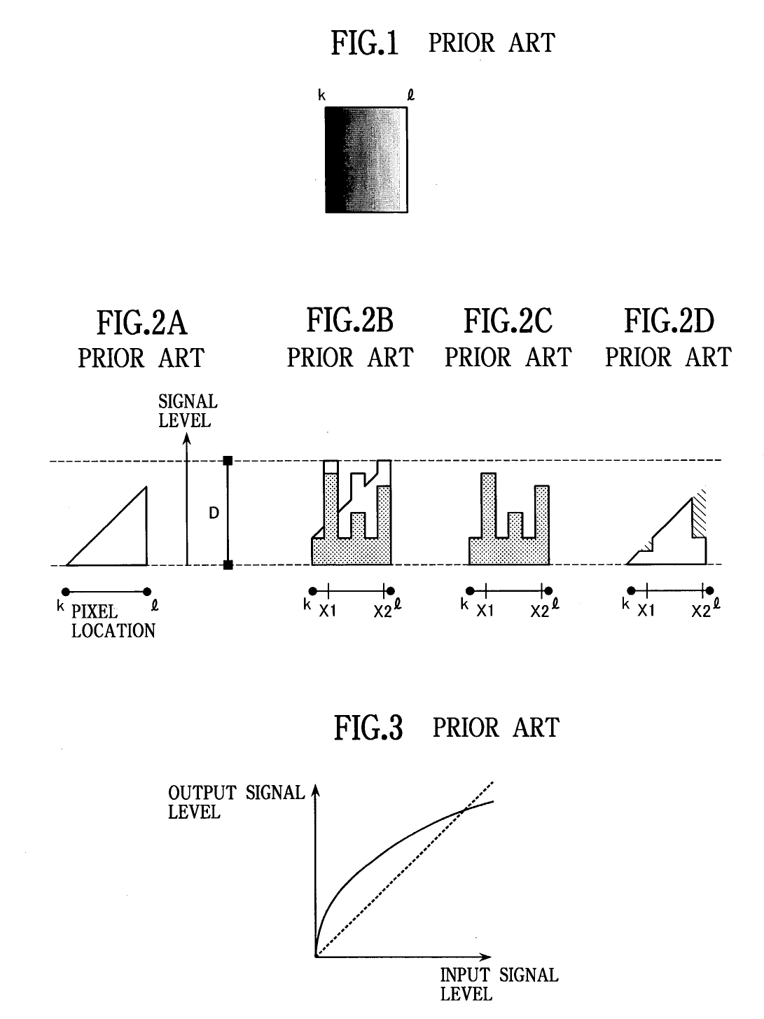

### DESCRIPTION OF THE PREFERRED EMBODIMENTS

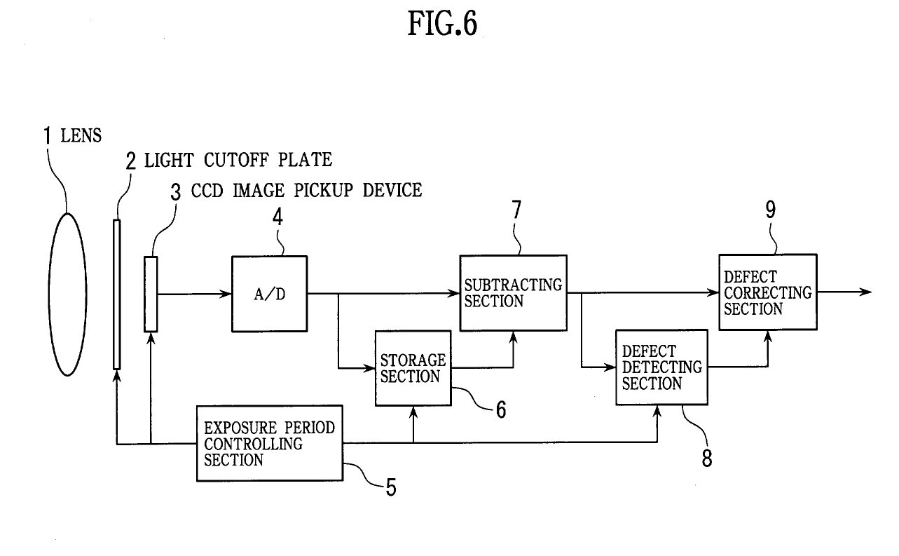

Some embodiments of the present invention will now be described. FIG. 6 is a block diagram showing a first embodiment of the image pickup apparatus according to the present invention. The invention is not limited to black-and-white image pickup apparatus and can be applied to image pickup apparatus of any type such as color image pickup apparatus. For ease of explanation, however, one applied to an electronic camera using black-and-white CCD image pickup device will be shown in the following embodiments including the present embodiment.

FIG. 6 includes: 1, a lens for causing an incidence of object light; 2, light cutoff plate; 3, CCD image pickup device for converting the object light into electrical signals; 4, an analog-to-digital converter for converting image pickup signals outputted from CCD image pickup device 3 into digital signals; and 5, an exposure period controlling section for controlling the light cutoff plate 2, CCD image pickup device 3 and a diaphragm (not shown) to control such as the exposure period of CCD image pickup device 3. Numeral 6 denotes a storage section consisting for example of DRAM for storing image pickup signals obtained from CCD image pickup device 3. It is in the first embodiment a dark signal storage section such as of DRAM which stores dark signals obtained from CCD image pickup device 3 in the condition where the incident light are cut off by the light cutoff plate 2.

Numeral 7 denotes a subtracting section for subtracting dark signals stored in the dark signal storage section 6 from main exposure image pickup signals obtained at CCD image pickup device 3 by a main exposure where the light cutoff plate 2 is withdrawn. The dark signal storage section 6 and subtracting section 7 constitute a dark current component canceling section. Numeral 8 denotes a defect detecting section for detecting fault pixels from the image pickup signals after the dark current component subtraction at the dark current component canceling section. Numeral 9 denotes a defect correcting section for performing correction of the fault pixels detected at the defect detecting section 8.

The above described exposure period controlling section 5 is formed for example by CPU for controlling the system. In addition to control of the light cutoff timing of the light cutoff plate 2 and charge accumulation time of CCD image pickup device 3 and control of diaphragm as described, it regulates dark signal storing timing at the dark signal storage section 6 and regulates various parameters to be used in the respective sections such as the defect detecting section 8 and defect correcting section 9.

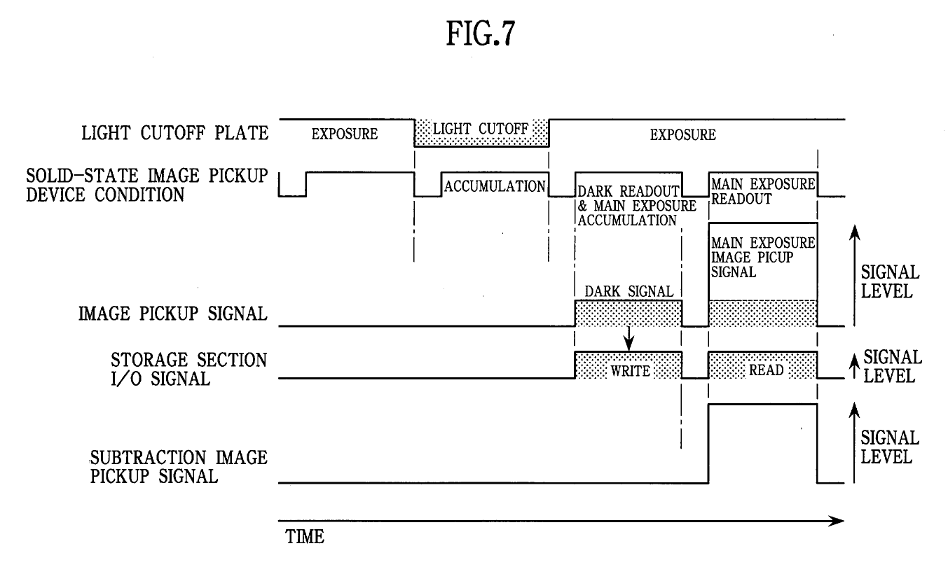

The operation of the image pickup apparatus according to the first embodiment having such construction will now be described. First, a description will be given below with reference to the timing chart shown in FIG. 7, with respect to the operation until the generation of image pickup signals subtracted of dark signals by the dark current component canceling section which is constituted by the dark signal storage section 6 and subtracting section 7. For ease of explanation, an example given here in the description is of one-shot image taking using CCD image pickup device of an interline readout system where exposure/accumulation time and readout time are the same as the frame rate and light is not cut off at the time of readout.

In the subtracting operation of dark signals, an accumulation of dark current charge of the same time duration as the exposure time of the main exposure image taking desired to be photographed is performed at CCD image pickup device 3 in the condition where the light cutoff plate 2 is first inserted into the optical path to cut off the incident light coming from lens 1. Thereby a dark signal output corresponding to the main exposure signals to be photographed is obtained from CCD image pickup device 3. Next, the main exposure image taking is started by withdrawing the light cutoff plate 2 from the optical path and at the same time the dark signals are read out and stored to the dark signal storage section 6. Next, the main exposure image pickup signals obtained by the main exposure image taking are read out from CCD image pickup device 3 and the dark signals stored at the dark signal storage section 6 are read out and subtraction processing of these is performed at the subtracting section 7. At this time, since dark current components corresponding to the dark signals are also contained in the main exposure image pickup signals obtained by the main exposure image taking, image pickup signals subtracted of the dark current components are outputted by the subtraction processing at the subtracting section 7.

In the present embodiment, with respect to thus obtained output signals from the subtracting section 7 subtracted of the dark current components, detection of fault pixels is performed at the defect detecting section 8 and correction processing is performed at the defect correcting section 9. While known methods can be used in the above described defect detection and correction processing, defects can be readily detected from the taken image and be corrected for example by applying the method disclosed in Japanese patent laid-open application No.11-18012 which is a patent application by the present inventor.

While there are various methods for detecting defects from an arbitrary image, an excessive accuracy in detecting the defects is not required in the present embodiment even in the condition of a frequent occurrence of defects especially resulting from an increase in dark current components, since the defect detection is performed after suppressing the dark current components. This also results in an advantage that smaller circuit size and power consumption suffice.

While the present embodiment has been shown as that performing subtraction of dark signals of CCD image pickup device 3 by using the light cutoff plate 2, storage section 6, and subtracting section 7, it is also possible that main exposure image pickup signals are stored to the storage section 6 and dark signals similarly obtained immediately after the main exposure image taking are subtracted from the main exposure image pickup signals stored in the storage section 6 to obtain image pickup signals subtracted of the dark current components.

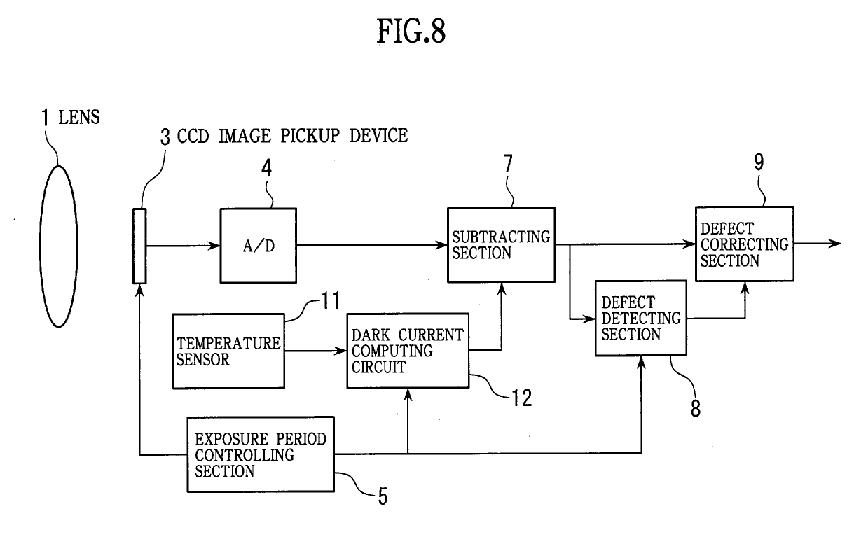

A second embodiment will now be described by way of FIG. 8. In the above first embodiment, memory means (storage section) corresponding to one frame and time for taking and storing the light cutoff condition are required to eliminate the dark current components. In the present embodiment, however, based on the fact that dark current components are roughly determined by a function of temperature and time, dark signals are inferred by computation from temperature and image taking time information so as to subtract such inferred dark signals from the main exposure image pickup signals.

In particular, as shown in FIG. 8, a temperature sensor 11 for sensing a temperature of CCD image pickup device 3 is disposed in the vicinity thereof. Dark current components are computed at a dark current computing circuit 12 based on the temperature information detected at the temperature sensor 11 and the image taking time set at the exposure period controlling section 5. Such dark current components are subtracted at the subtracting section 7.

Due to the problem of pixel-by-pixel variance in the dark currents, the predicted values and actual values, by nature, rarely coincide. Even when the predicted dark signals are subtracted, the advantage is slim and defect-like pixel signals remain. In the present embodiment, however, these can be eliminated by thereafter performing defect detection/correction at the defect detecting section 8 and defect correcting section 9. Further, naturally, price/power is also greatly reduced, since the storage section 6 and light cutoff plate 2 in the first embodiment are eliminated.

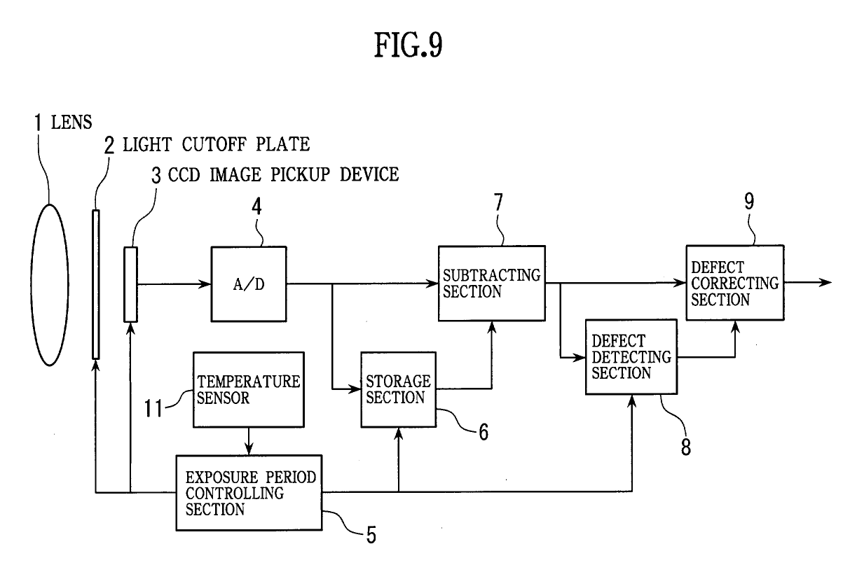

A third embodiment will now be described by way of FIG. 9. In this embodiment, temperature sensor 11 is disposed in the vicinity of CCD image pickup device 3 in the first embodiment shown in FIG. 6 so as to transmit the temperature information detected at the temperature sensor 11 to the exposure period controlling section 5.

As in the first embodiment shown in FIG. 6, even if the taking periods are the same in length in the case of acquiring signals corresponding to two frames, i.e., the main exposure image pickup signals and dark signals to perform subtraction, the taking timings are different from each other so that an error in dark current components occurs corresponding to rise or drop in temperature between these. As previously described, this is because the dark current components are related to time and temperature. The temperature sensor 11 is thus disposed in the vicinity of CCD image pickup device 3 as described to thereby detect temperature difference at the time of image taking between the two frames by the main exposure taking and the dark taking. The amount of such temperature change is then converted into charge accumulation time at the exposure period controlling section 5. CCD image pickup device 3 or light cutoff plate 2 is controlled to adjust the charge accumulation time of the second frame with respect to the charge accumulation time of the first frame. It is thereby possible to roughly cancel the error in dark currents resulting from temperature difference between the two frames. Such canceling of dark current error becomes more advantageous as the main exposure image taking time becomes longer and as the temperature changes more sharply.

A fourth embodiment will now be described. If it is attempted to eliminate dark current components by using both the main exposure image pickup signals and dark signals as in the first embodiment shown in FIG. 6, the operability of image pickup apparatus becomes inferior due to the fact that two frame periods are required to obtain one image. On the other hand, since a dark current component has the property of being proportional to time, the signal thereof is predictable to some extent. In the present embodiment, thus, dark signals of a period shorter than a main exposure image taking period are obtained and dark current components corresponding to the main exposure image taking period are predicted by computation from the shorter-period dark signals to perform subtraction.

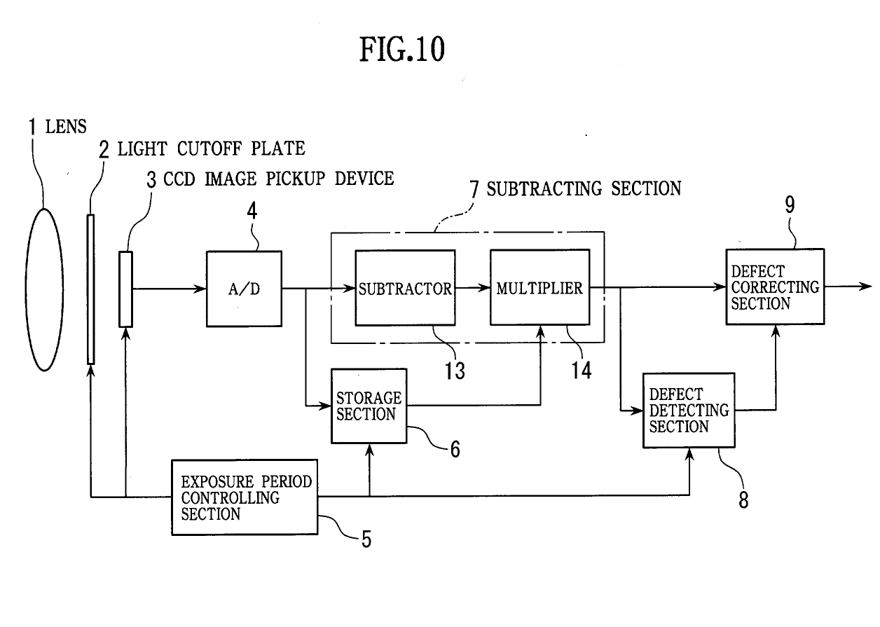

FIG. 10 is a block diagram showing the fourth embodiment. The subtracting section 7 includes a multiplier 13 for multiplying the dark signals from the analog-to-digital converter 4 by N times and a subtractor 14 for subtracting the dark signals multiplied by N at the multiplier 13 from the main exposure image pickup signals stored at the storage section 6. The construction of the other parts is similar to the first embodiment shown in FIG. 6.

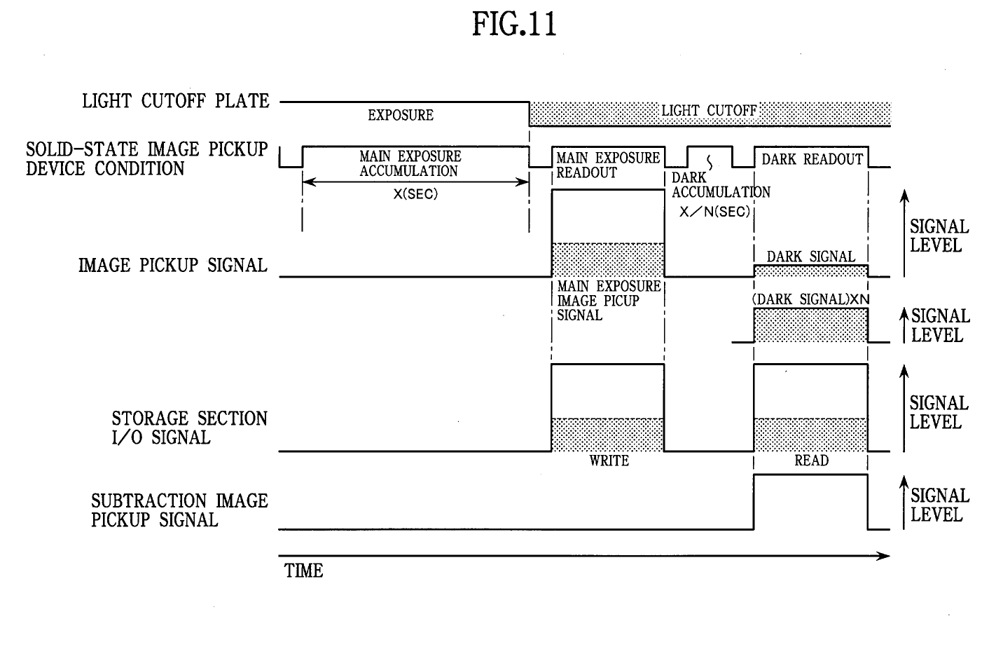

The operation of the fourth embodiment having such construction will now be described by way of the timing chart of FIG. 11. In the first embodiment, the storage section 6 is constructed to take in dark signals. In the fourth embodiment, however, the storage section 6 serves as the main exposure image pickup signal storage section as described above so that the main exposure image pickup signals in the condition of withdrawing the light cutoff plate 2 from the optical path are taken into the storage section 6. Further, for ease of explanation, a description is given here by exemplifying one-shot image taking using CCD image pickup device of full-frame readout system in which light must be cut off at the time of readout.

First in the subtracting operation of dark signals, the main exposure image pickup signals from CCD image pickup device 3 are stored to the main exposure image pickup signal storage section 6 in the condition where the light cutoff plate 2 is withdrawn from the optical path. The dark current charge accumulation of a period corresponding to 1/N (N≠0) of an image taking time X (sec) of the main exposure image taking previously taken at CCD image pickup device 3 is then performed in the condition where the incident light from lens 1 is cut off by inserting the light cutoff plate 2 into the optical path. The accumulated dark current charge is then read out and multiplied by N at the multiplier 13 and the main exposure image pickup signals stored at the main exposure image pickup signal storage section 6 are read out so as to perform subtraction processing between these at the subtractor 14.

At this time, since the main exposure image pickup signals obtained by the main exposure image taking contain dark current components corresponding to about N times the dark signals taken with cutting off the light, the processing to be performed is a subtraction from the main exposure image pickup signals of what is obtained by multiplication of N times of the dark signals of an accumulation period 1/N times the main exposure image taking period. The image pickup signals subtracted of the dark current components are thereby outputted. It should be noted that, while in the above description the storage section 6 is for storing main exposure image pickup signals, it is also possible to store dark signals instead of the main exposure image pickup signals.

A fifth embodiment will now be described. In the above fourth embodiment, dark signals of the accumulation time of 1/N of the main exposure image pickup signals are taken for one frame and then multiplied by N. In the present embodiment, on the other hand, dark signals of 1/N accumulation time are taken for N frames and added together to suppress random noise components of the dark signals. While a random noise component is necessarily superimposed on the signal component, this can be regarded to vary evenly for the same one pixel. Accordingly, the pixel-by-pixel variance can be suppressed by the integration effect.

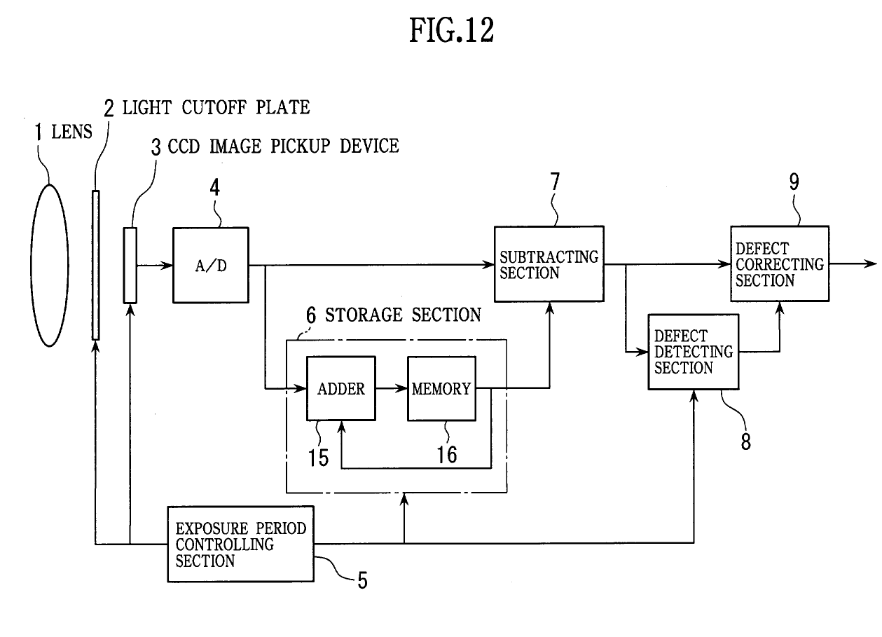

The fifth embodiment having adding configuration of N frames of dark signals of 1/N accumulation time is shown in FIG. 12. In this embodiment, the dark signal storage section 6 in the first embodiment shown in FIG. 6 is constructed as shown in FIG. 12. In particular, dark signals from CCD solid-state image pickup device 3 and dark signals from memory 16 are added pixel by pixel at the same location by the adder 15 and stored again to memory 16, thereby the dark signals consecutively inputted in sequence are successively added, and dark current components of an equivalent level as those contained in the main exposure image pickup signals can be obtained at the end with less random noise. It should be noted that the memory 16 is of FIFO construction where readout and writing can be concurrently performed.

By such construction, dark signals added for N frames having integrated random noise are stored in the dark signal storage section 6 after the taking of N frames of dark signals. By subtracting such integrated dark signals from the main exposure image pickup signals, a dark current suppression with less noise becomes possible so that an image having favorable S/N can be obtained.

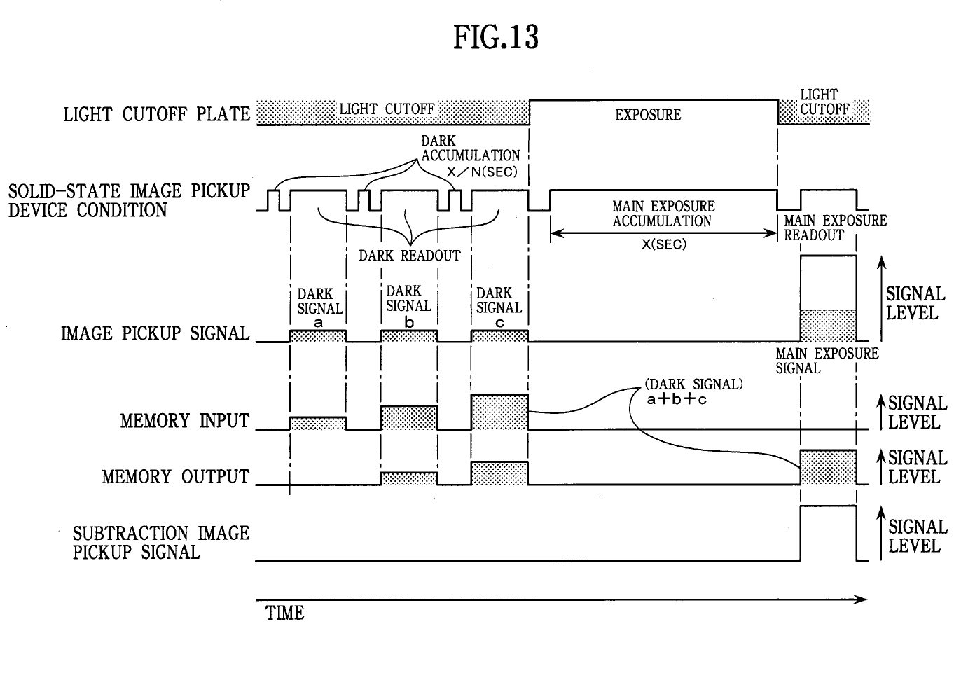

An operation timing chart of the image pickup apparatus having such construction is shown in FIG. 13. In the subtracting operation of the dark signals, an accumulation of dark current charge of a period corresponding to 1/N times the main exposure image taking time is first performed at CCD image pickup device 3 in the condition where the incident light from lens 1 is cut off by inserting the light cutoff plate 2 in the optical path, and then the accumulated dark current charge is read out. Such operation is repeated for N frames (3 frames in the example shown) so as to store dark signals suppressed of random noise to the dark signal storage section 6. It is thereby possible to obtain the dark signal outputs corresponding to the main exposure image pickup signals desired to be photographed. Next, the main exposure image taking where the light cutoff plate 2 is withdrawn from the optical path is started and the dark signals stored at the dark signal storage section 6 are read out so as to perform subtraction processing between these at the subtracting section 7.

As the above, it is possible to perform a dark current component subtraction where random noise is suppressed in a shorter image taking period. For the generation of the dark signals to be finally obtained, it can be generated by a cyclic filter construction of N frames instead of generation by addition of N frames.

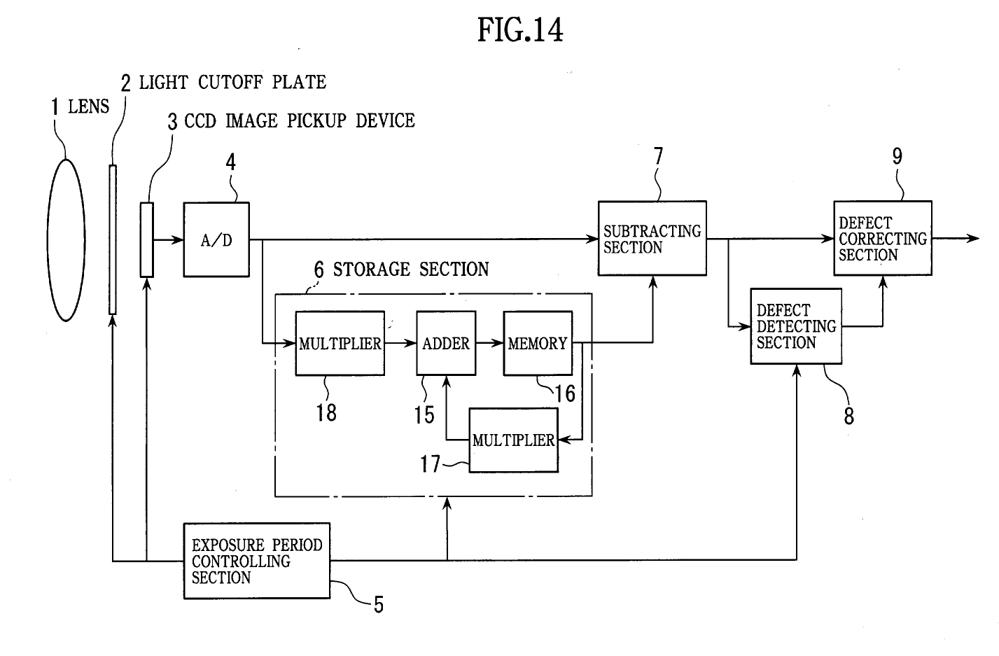

Here, the cyclic filter refers to one as shown in FIG. 14. Instead of successively adding in a simple manner, ratio in addition is changed for example between (n+1)-th frame and n-th frame (n≧2) so as to perform integration with putting respective weights on new and old data. In particular, the dark signals of (n+1)-th frame multiplied by “a” at multiplier 18 and the image pickup signals of n-th frame multiplied by (1−a) at multiplier 17 are added at adder 15 and successively stored to memory 16 (here, 1≧a>0).

In this manner, since the integration effect can be controlled in accordance with the weighted values, a substantially equivalent random noise suppressing effect can be obtained without depending on frame number N by changing “a” in accordance with the frame number N even in the case where the frame number N is changed for example in accordance with the main exposure image pickup time without fixing it at all times in the image pickup apparatus.

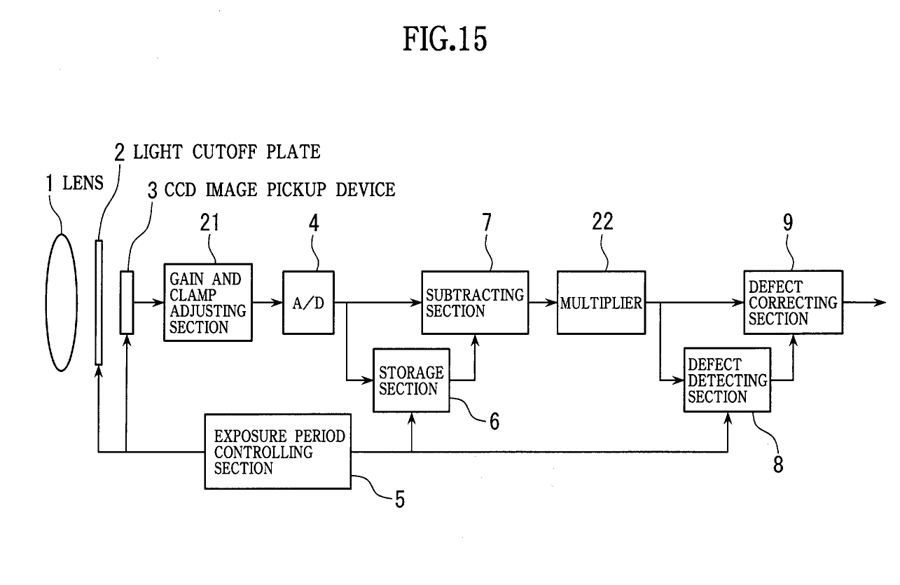

A sixth embodiment will now be described by way of the block diagram of FIG. 15. In this embodiment, a gain and clamp regulating section 21 is provided at a preceding stage of the analog-to-digital converter 4 of the first embodiment shown in FIG. 6, and a multiplier 22 at a subsequent stage of the subtractor 7, respectively. It is a premise here that the dynamic range limitation of the circuit is caused at the analog-to-digital converter 4, in which case signals having an expanded dynamic range can be obtained by providing the gain and clamp regulating section 21 at the preceding stage thereof and the multiplier 22 after the dark current component subtraction. In particular, the signals from CCD image pickup device 3, which have been regulated of gain and clamp level at the gain and clamp regulating section 21, are caused to be transmitted through the analog-to-digital converter 4 and, after the dark current subtraction at the subtracting section 7, are multiplied by a predetermined number at the multiplier 22.

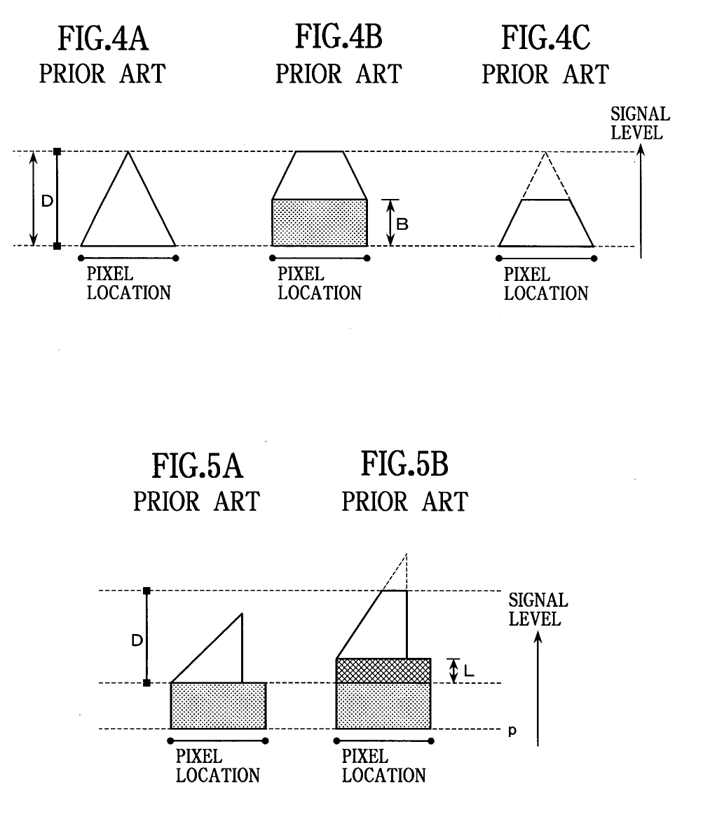

As previously described by way of FIGS. 4A to 4C in respect of known techniques, supposing the circuit dynamic range of the analog-to-digital converter 4 as D (mV), since, in a long-time exposure image taking, the dark current component B is increased as the dotted pattern portion of the signal waveform shown in FIG. 4B, the waveform shown in FIG. 4C clipped of an upper portion of the waveform shown in FIG. 4A to be originally obtained when the dark current component B (mV) is absent is delivered to the subsequent stage from the analog-to-digital converter 4. In other words, instead of an output of D (mV) to be originally obtained, only a maximum output of (D−B) (mV) can be obtained.

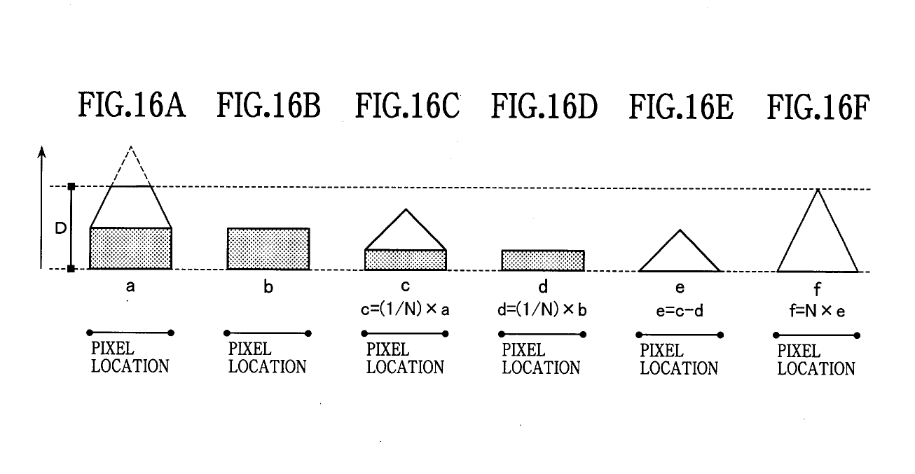

In the present embodiment, therefore, as shown in FIGS. 16A and 16B, the main exposure image pickup signal “a” and dark signal “b” from CCD image pickup device 3 are respectively caused to be transmitted through the analog-to-digital converter 4 as multiplied by 1/N at the gain and clamp regulating section 21 as shown in FIGS. 16C and 16D (1/N-times main exposure signal “c”, 1/N-times dark signal “d”). As shown in FIGS. 16E and 16F, then, signal “e” (e=c−d) after the dark current subtraction processing is multiplied by N (N>0) at the multiplier 22 so that main exposure image pickup signal “f” after the dark current subtraction can be obtained as having a dynamic range D (mV) without clipping of an upper portion.

While in the above sixth embodiment, its main portion has been applied to the first embodiment, such main portion of the embodiment can be applied also to the second embodiment shown in FIG. 8. In this case, it suffices that the dark current components obtained at the dark current computing circuit 12 are inputted to the gain and clamp regulating section 21.

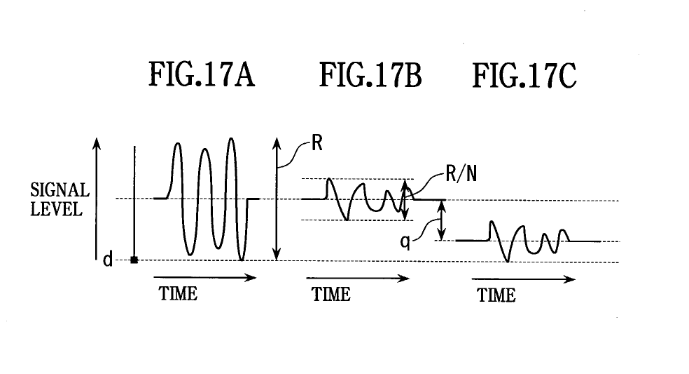

In the clamping operation for bringing the reference level of signal to a constant, on the other hand, while the clamp level is set by considering the peak-to-peak value of random noise amount, the multiplication of signal by a predetermined number results in the multiplication of the noise component by the predetermined number with respect to the dynamic range of the circuit. Here, since the random noise amount also becomes 1/N in the condition where it is multiplied by 1/N, a signal processing more effectively using the dynamic range becomes possible by correspondingly lowering the clamp level. This will be explained below using FIGS. 17A to 17C.

Random noises are generally treated as the so-called Gaussian noise of equal probability having predetermined maximum and minimum values. Supposing, as shown in FIG. 17A, the lower limit level of dynamic range as d (mV) and the maximum amplitude of random noise as R (mV), a most effective dynamic range is obtained by setting the clamp level to (d+R/2) (mV).

Supposing now that signal is multiplied by 1/N (N>0) in the condition of most favorable clamp level, the maximum amplitude of the random noise becomes R/N (mV) as shown in FIG. 17B, where the dynamic range is wasted correspondingly to (R/2)×(1−(1/N)) (mV) if the clamp level is left fixed. Accordingly, the dynamic range can be maximally utilized by bringing higher or lower the clamp level by a shifting amount q=(R/2)×(1−(1/N)) (mV) as shown in FIG. 17C. Here the clamp level is to be lowered if q is positive while the clamp level is raised when it is negative.

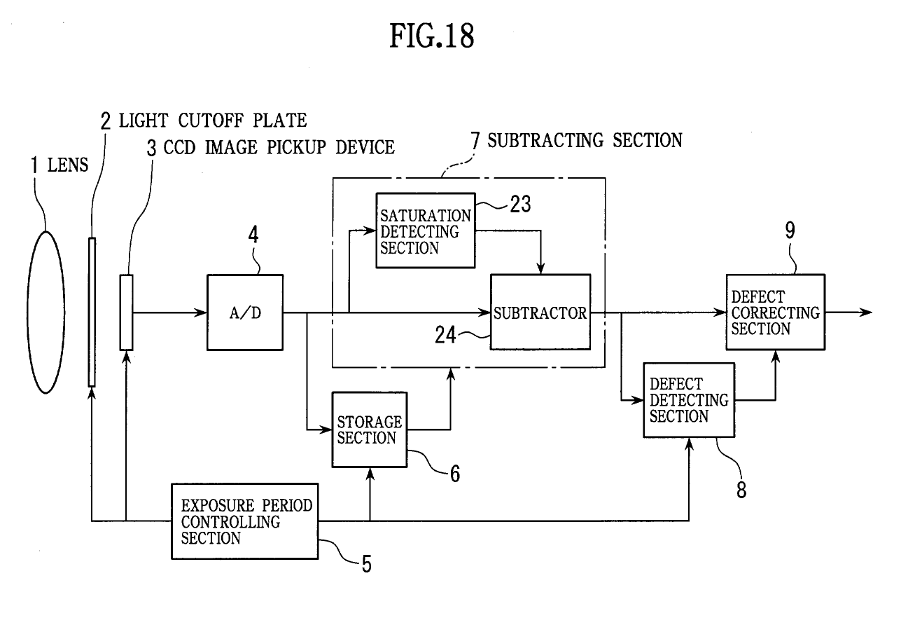

A seventh embodiment will now be described by way of FIG. 18. In this embodiment, the internal composition of the subtracting section 7 in the first embodiment shown in FIG. 6 is constructed as illustrated. In particular, a saturation detecting section 23 is the circuit for determining whether the pixel signal of the inputted main exposure image pickup signals has reached saturation of the circuit or not. If it is determined as saturated at the saturation detecting circuit 23, the subtraction of dark signal at the subtractor 24 is not to be performed on a pixel-by-pixel basis.

A variance by the pixel occurs in the dark current components as shown in FIGS. 2A to 2D of known techniques, and such variance becomes conspicuous especially, for example, in a long-time exposure image taking. By the dark current subtraction processing as has been described, abnormal signal level resulting from the dark current variance can be canceled for many of the pixels by the pixel-by-pixel subtraction of dark signals from main exposure image pickup signals. In those pixels where the main exposure image pickup signal has reached the saturation of the circuit while the dark signal has not reached the saturation, however, the main exposure image pickup signal components are cut down and result in the waveform as shown in FIG. 2D. These dark current subtraction error pixels are processed as fault pixels at the defect detecting/correcting section of subsequent stage. Especially in the case of defects toward the lower luminance side which cannot be detected as defects due to the fact that the difference with the surrounding normal pixels is small, however, these become extremely conspicuous as undetected defects within the image as a result that a higher gain is multiplied for the lower luminance side at the subsequent-stage processing as compared to the higher luminance side as described in respect of the above known techniques.

In the present embodiment, the defect detection at subsequent stage is made easier with respect to such dark current subtraction processing error pixels. In particular, of those saturated pixels in the main exposure image pickup signals, the true signal components are already lost, and these cannot be brought to normal level and become errors even if dark current subtraction processing is performed. Therefore the subtraction processing is not performed for the saturated pixels and the main exposure image pickup signal thereof is delivered to the subsequent stage without change.

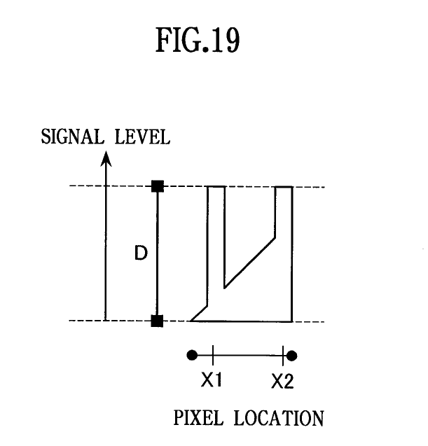

By the above processing, the signals after dark current subtraction are changed from of the waveform shown in FIG. 2D to of the waveform shown in FIG. 19. In particular, the difference with the surrounding normal pixels becomes conspicuous for the pixels of X1, X2 of which signal components have been cut down, especially with respect to X1 pixel at the lower luminance side of which the difference with the surrounding pixels after the cut-down has become smaller. It thus becomes easier to detect the lower-luminance side dark current subtraction error pixels as defects. It should be noted that main portions of this embodiment can be applied also to the second embodiment shown in FIG. 8.

An eighth embodiment will now be described. A diagrammatic representation of this embodiment is the same as the seventh embodiment shown in FIG. 18 and will be omitted. The storage section 6 serves as a main exposure image pickup signal storage section 6 and stores main exposure image pickup signals which are the output signals from CCD image pickup device 3 in the condition where the light cutoff plate 2 is withdrawn from the optical path. The subtracting section 7 includes the saturation detecting section 23 similarly to the seventh embodiment shown in FIG. 18.

In thus constructed image pickup apparatus, after acquiring one frame of the main exposure image pickup signals as shown in the timing chart of FIG. 11, such one frame of the main exposure image pickup signals is stored to the storage section 6 and dark signals are acquired at the next frame in the condition where the incident light is cut off by the light cutoff plate 2. At this time, a degree of saturation of the main exposure image pickup signals is computed at the saturation detecting section 23. If, from this result, the degree of saturation of main exposure image pickup signals exceeds a predetermined level, the dark signal acquiring operation of the second frame and after is stopped by control of the exposure period controlling section 5 and at the same time an indication is made to the photographer that optimum main exposure image pickup signals will not be obtained.

As the method of computing the degree of saturation, the following for example suffices. A determination as to saturation is made for each pixel, and main exposure image pickup signals are regarded as signals of high saturation if the number of saturated pixels exceeds 50% within one frame of the main exposure image pickup signals. Here it is naturally also possible to perform the saturation determination for example at intervals of several pixels or for only a predetermined area without performing the saturation determination by the pixel for all pixels. Further, the indication to the photographer can be made for example as follows. In image pickup apparatus having a finder or displaying LCD, it suffices to display “Suitable Photographing Impossible”, “Exposure Readjustment Required”, etc. It is also possible to indicate by an on-and-off of LCD or the like.

Since a waste image taking operation can be avoided by the above, a loss in photographing timing can be eliminated and photographing operability especially for example in a long-time exposure image taking is improved. It is also possible by a similar construction for the image pickup apparatus side to automatically set image taking time and exposure amount through the saturation detecting section and exposure period controlling section so as to achieve an optimum saturation level for example when exposure amount is small. Further, the saturation degree computation result at the saturation detecting section 23 and moreover information relating to optimum image taking time and exposure can be directly indicated to the photographer for example through a finder or displaying LCD.

A ninth embodiment will now be described. The configuration of this embodiment is identical to the third embodiment shown in FIG. 9 and will not be explained. The present embodiment can be applied also to the second embodiment shown in FIG. 8. The dark current component level of CCD image pickup device 3 permanently retains substantially constant characteristics with respect to temperatures/image taking time. For this reason, if CCD image pickup device 3 to be used is predetermined, the dark current components in the pertinent environment can be inferred by acquiring an information of temperature and image taking time. It is thus possible to determine whether or not a dark current component subtraction processing should be effected for a main-exposure taken image desired to be photographed. Accordingly, it is automatically determined at the exposure period controlling section 5 from the temperature information obtained at the temperature sensor 11 and image taking time information obtained at the exposure period controlling section 5 whether or not the dark current subtraction processing is to be performed by acquiring dark signals or whether or not the dark current subtraction processing is to be performed by computing dark current components. The photographer can thus obtain an excellent image with less fault pixels at all times without a waste of timing loss in photographing by effecting a dark current subtraction processing as required according to the judgment by the exposure period controlling section 5.

As has been described by way of the above embodiment, according to the first aspect of the invention, an image pickup apparatus can be achieved as capable of accurately detecting and correcting fault pixels even when the fault pixels occur in every portion of image for example in a long-time exposure image taking. With the second aspect of the invention, since it is not necessary to obtain dark signals at the time of cutting off light, the dark current components can be subtracted without a loss in the image taking time to detect and correct fault pixels for example even at the time of a long-time exposure image taking. With the third aspect of the invention, dark current components can be accurately subtracted to detect and correct fault pixels even in the condition of drastically changing temperatures. With the fourth aspect of the invention, prescribed dark signals can be obtained in a short time period so that a relatively accurate dark current suppressing effect can be achieved with a smaller loss in the image taking time. With the fifth aspect of the invention, defects can be detected and corrected by subtracting dark current components in the condition where the dynamic range of circuit is maximally utilized. With the sixth aspect of the invention, a maximum dynamic range can be utilized with considering the influence of random noise.

With the seventh aspect of the invention, an image having a favorable S/N can be obtained by subtracting dark current components having suppressed random noise components to detect and correct fault pixels. With the eighth aspect of the invention, detection of detects, especially those of lower luminance side, at a subsequent stage can be made easier with respect to the fault pixels after the subtraction of dark current components. With the ninth and tenth aspects of the invention, it is possible not to perform processing of wasteful main exposure image pickup signals which are not of an optimum exposure. With the eleventh aspect of the invention, the exposure condition can be optimized so that acquisition of abnormal image can be prevented. With the twelfth aspect of the invention, the photographer can perform an optimum image taking with recognizing an optimum image taking time and exposure amount. With the thirteenth aspect of the invention, an advantage of dark current subtraction can be suitably obtained as required without causing the photographer side to operate the image pickup apparatus.

What is claimed is:

1. An image pickup apparatus comprising:
an image pickup device having a plurality of pixels for effecting photoelectric conversion of an incident light;
light cutoff means for cutting off the incident light onto said image pickup device;
exposure control means for setting and controlling diaphragm stop and image taking time;
memory means for storing an output of said image pickup device;
subtraction means for subtracting dark signals obtained at said image pickup device at the time of cutting off the incident light by said light cutoff means from main exposure image pickup signals obtained at said image pickup device at the time of main exposure image taking where said light cutoff means is withdrawn;
detection means for detecting defect signals due to fault pixels of said image pickup device from the image pickup signals after the subtraction processing obtained at the subtraction means; and
correction means for correcting the defect signals.

2. An image pickup apparatus comprising:
an image pickup device having a plurality of pixels for effecting photoelectric conversion of an incident light;
temperature detection means for detecting a temperature of said image pickup device;
exposure control means for setting and controlling diaphragm stop and image taking time;
dark signal computing means for generating by computation dark signals of said image pickup device on the basis of the temperature detected by said temperature detection means and the image taking time set by said exposure control means;
subtraction means for subtracting the dark signals obtained at said dark signal computing means from main exposure image pickup signals obtained at said image pickup device at the time of main exposure image taking;
detection means for detecting defect signals due to fault pixels of said image pickup device from the image pickup signals after the subtraction processing obtained at the subtraction means; and
correction means for correcting the defect signals.

3. The image pickup apparatus according to claim 1, wherein said light cutoff means is capable of setting a light cutoff period corresponding to the taking time of the main exposure image taking.

4. The image pickup apparatus according to claim 1 further comprising temperature detection means for detecting a temperature of said image pickup device, wherein said exposure control means effects control so that a light cutoff period corresponding to the temperature detected at said temperature detection means can be set to said light cutoff means.

5. The image pickup apparatus according to claim 1, wherein said subtraction means comprises adjusting means for multiplying the level of dark signals at the time of cutting off the incident light by a predetermined number of times, and the level of dark signals at the time of cutting off the incident light obtained by setting a light cutoff period shorter than the image taking time of the main exposure image taking to said light cutoff means is multiplied by a predetermined number of times by said adjusting means and then subtracted from the main exposure image pickup signals.

6. The image pickup apparatus according to claim 1 further comprising a first adjusting means for multiplying the level of image pickup signals from said image pickup device by 1/N (N≠0) times, and a second adjusting means for multiplying the image pickup signals after the subtraction processing by N times, wherein said first adjusting means multiplies by 1/N the main exposure image pickup signals and dark signals obtained at the time of cutting off the incident light and said second adjusting means multiplies by N the image pickup signals after the subtraction processing having been subjected to the subtraction processing at said subtraction means.

7. The image pickup apparatus according to claim 2 further comprising a first adjusting means for multiplying the level of image pickup signals from said image pickup device by 1/N (N≠0) times, and a second adjusting means for multiplying the image pickup signals after the subtraction processing by N times, wherein said first adjusting means multiplies by 1/N the main exposure image pickup signals and dark signals obtained from said dark signal computing means and said second adjusting means multiplies by N the image pickup signals after the subtraction processing having been subjected to the subtraction processing at said subtraction means.

8. The image pickup apparatus according to claim 6, wherein said first adjusting means causes the level for clamping the image pickup signals from said image pickup device to vary correspondingly to image taking time.

9. The image pickup apparatus according to claim 7, wherein said first adjusting means causes the level for clamping the image pickup signals from said image pickup device to vary correspondingly to image taking time.

10. The image pickup apparatus according to claim 1, wherein said memory means integrates for a plurality of frames and stores dark signals obtained at the time of cutting off the incident light by said light cutoff means and said subtraction means subtracts said integrated dark signals from the main exposure image pickup signals.

11. The image pickup apparatus according to claim 1 further comprising determining means for determining whether a circuit-saturated pixel signal occurs within said main exposure image pickup signals or not, wherein said subtraction means does not perform subtraction processing for the circuit-saturated pixel signals occurring within the main exposure image pickup signals as determined by said determining means and outputs the same as an output signal of the subtraction means without change.

12. The image pickup apparatus according to claim 2 further comprising determining means for determining whether a circuit-saturated pixel signal occurs within said main exposure image pickup signals or not, wherein said subtraction means does not perform subtraction processing for the circuit-saturated pixel signals occurring within the main exposure image pickup signals as determined by said determining means and outputs the same as an output signal of the subtraction means without change.

13. The image pickup apparatus according to claim 1, wherein the main exposure image pickup signals are obtained before acquiring dark signals at the time of cutting off the incident light.

14. The image pickup apparatus according to claim 13 further comprising:
detection means for detecting a circuit-saturated condition of image pickup signal at the time of the main exposure image taking; and
means for deciding whether or not to acquire dark signals at the time of cutting off the incident light in accordance with the circuit-saturated condition detected by the detection means.

15. The image pickup apparatus according to claim 13 further comprising detection means for detecting circuit-saturated condition of image pickup signal at the time of the main exposure image taking, wherein said exposure control means controls said image taking time and exposure amount in accordance with the circuit-saturated condition detected by said detection means.

16. The image pickup apparatus according to claim 13 further comprising:
detection means for detecting a circuit-saturated condition of image pickup signal at the time of the main exposure image taking; and
means for indicating to the photographer an information relating to an optimal image taking time and exposure amount in accordance with the circuit-saturated condition detected by the detection means.

17. The image pickup apparatus according to claim 1 further comprising:
temperature detection means for detecting a temperature of said image pickup device; and
means for deciding whether or not to perform dark current subtraction processing by acquiring dark signals at the time of cutting off the incident light in accordance with a temperature detection result detected by the temperature detection means and the diaphragm stop and image taking time set by said exposure control means.

18. The image pickup apparatus according to claim 2 further comprising:
temperature detection means for detecting a temperature of said image pickup device; and
means for deciding whether or not to perform dark current subtraction processing by computing dark signals at said dark signal computing means in accordance with a temperature detection result detected by the temperature detection means and the diaphragm stop and image taking time set by said exposure control means.
